(19) United States
(12) Patent Application Publication
(10) Pub. No.: US 2013/0346283 A1
(43) Pub. Date: Dec. 26, 2013

(54) System and Method for Processing a Decision Engine Driven Integrated Consumer Credit Application

(71) Applicants: Steven Demarest, Elkton, MD (US); Scott L. Godsey, Hockessin, DE (US); Douglas M. Jones, Aston, PA (US); Rachelle L. Krueger, Scottsdale, AZ (US); Michael J. Leary, North Wales, PA (US)

(72) Inventors: Steven Demarest, Elkton, MD (US); Scott L. Godsey, Hockessin, DE (US); Douglas M. Jones, Aston, PA (US); Rachelle L. Krueger, Scottsdale, AZ (US); Michael J. Leary, North Wales, PA (US)

(73) Assignee: Bank of America Corporation, Charlotte, NC (US)

(21) Appl. No.: 13/530,932

(22) Filed: Jun. 22, 2012

(51) Int. Cl. G06Q 40/02

(52) U.S. Cl. 705/38

(57) ABSTRACT

In certain embodiments, a system includes a processor. The system also includes one or more non-transitory computer readable storage media embodying software that is operable when executed by the processor to perform certain operations. The operations include receiving a credit application request from an applicant directed to a credit entity. The credit application request includes a product selection. The operations also include determining a relationship strength between the applicant and the credit entity. The operations also include receiving a plurality of responses to requests for applicant data. The operations also include determining an applicant classification based at least in part on one or more of the product selection and the relationship strength. The operations also include determining, based on the applicant classification, one or more applicant data collection rules. The operations also include customizing requests for additional applicant data using the determined one or more applicant data collection rules.

### TECHNICAL FIELD OF THE INVENTION

The present invention relates generally to electronic systems and more specifically to a system for processing a decision engine driven integrated consumer credit application.

### BACKGROUND OF THE DISCLOSURE

Credit entities may offer various credit products. Credit entities may wish to use an application process to collect information from applicants to determine whether to extend credit to the applicants. However, systems and methods supporting credit applications have proven inadequate in various respects.

### SUMMARY OF THE DISCLOSURE

In certain embodiments, a system includes a processor. The system also includes one or more non-transitory computer readable storage media embodying software that is operable when executed by the processor to perform certain operations. The operations include receiving a credit application request from an applicant directed to a credit entity. The credit application request includes a product selection. The operations also include determining a relationship strength between the applicant and the credit entity. The operations also include receiving a plurality of responses to requests for applicant data. The operations also include determining an applicant classification based at least in part on one or more of the product selection and the relationship strength. The operations also include determining, based on the applicant classification, one or more applicant data collection rules. The operations also include customizing requests for additional applicant data using the determined one or more applicant data collection rules.

In further embodiments, a method includes receiving, by a processor, a credit application request from an applicant directed to a credit entity. The credit application request includes a product selection. The method also includes determining, by the processor, a relationship strength between the applicant and the credit entity. The method also includes receiving, by the processor, a plurality of responses to requests for applicant data. The method also includes determining, by the processor, an applicant classification based at least in part on one or more of the product selection and the relationship strength. The method also includes determining, by the processor, based on the applicant classification, one or more applicant data collection rules. The method also includes customizing, by the processor, requests for additional applicant data using the determined one or more applicant data collection rules.

In some embodiments, a system includes a memory operable to store data. The data includes applicant data collection rules. The system also includes a processor communicatively coupled to the memory. The processor is operable to perform certain operations. The operations include receiving a credit application request from an applicant directed to a credit entity. The credit application request includes a product selection. The operations also include determining a relationship strength between the applicant and the credit entity. The operations also include receiving a plurality of responses to requests for applicant data. The operations also include determining an applicant classification based at least in part on one or more of the product selection and the relationship strength. The applicant classification includes one of a preferred classification, a credit builder classification, a non-relationship classification, and a student classification.

The operations also include determining a first set of applicant data collection rules from the applicant data collection rules if the applicant classification is a preferred classification. The operations also include determining a second set of applicant data collection rules from the applicant data collection rules if the applicant classification is a credit builder classification. The operations also include determining a third set of applicant data collection rules from the applicant data collection rules if the applicant classification is a non-relationship classification. The operations also include determining a fourth set of applicant data collection rules from the applicant data collection rules if the applicant classification is a student classification. The operations also include customizing requests for additional applicant data using the determined set of applicant data collection rules.

Particular embodiments of the present disclosure may provide some, none, or all of the following technical advantages. By customizing requests for applicant information, certain embodiments may prevent applicants from being asked unnecessary questions. By eliminating the need for unnecessary questions, some embodiments may increase the number of completed applications by reducing the number of applicants who begin but do not complete the application process. In addition, by customizing requests for applicant information, certain embodiments may collect additional information that may reflect favorably on the applicant, which may increase the percentage of applications that are approved. Moreover, by customizing requests for applicant information, certain embodiments may collect additional information that may reflect unfavorably on the applicant, which may allow the credit entity to have a clearer picture of the risk associated with extending credit to the applicant. Certain embodiments may also increase efficiency of credit application processing and reduce the need for human labor. For example, by providing for the possibility of requesting post-agency applicant data, certain embodiments may reduce the number of applications that may need to be reviewed by a credit analyst.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates an example system for processing a credit application, according to certain embodiments of the present disclosure;

FIG. 2 illustrates an example method for processing a credit application, according to certain embodiments of the present disclosure;

FIG. 3 illustrates an example method for collecting applicant information in connection with a credit application, according to certain embodiments of the present disclosure;

FIG. 4 illustrates another example method for collecting applicant information in connection with a credit application, according to certain embodiments of the present disclosure;

FIGS. 5A-5B illustrate another example method for collecting applicant information in connection with a credit application, according to certain embodiments of the present disclosure;

FIGS. 6A-6B illustrate another example method for collecting applicant information in connection with a credit application, according to certain embodiments of the present disclosure;

FIG. 7 illustrates another example method for collecting applicant information in connection with a credit application, according to certain embodiments of the present disclosure; and

FIG. 8 illustrates an example screenshot of an applicant data collection window that may be generated by the system of FIG. 1, according to certain embodiments of the present disclosure.

### DETAILED DESCRIPTION OF THE DRAWINGS

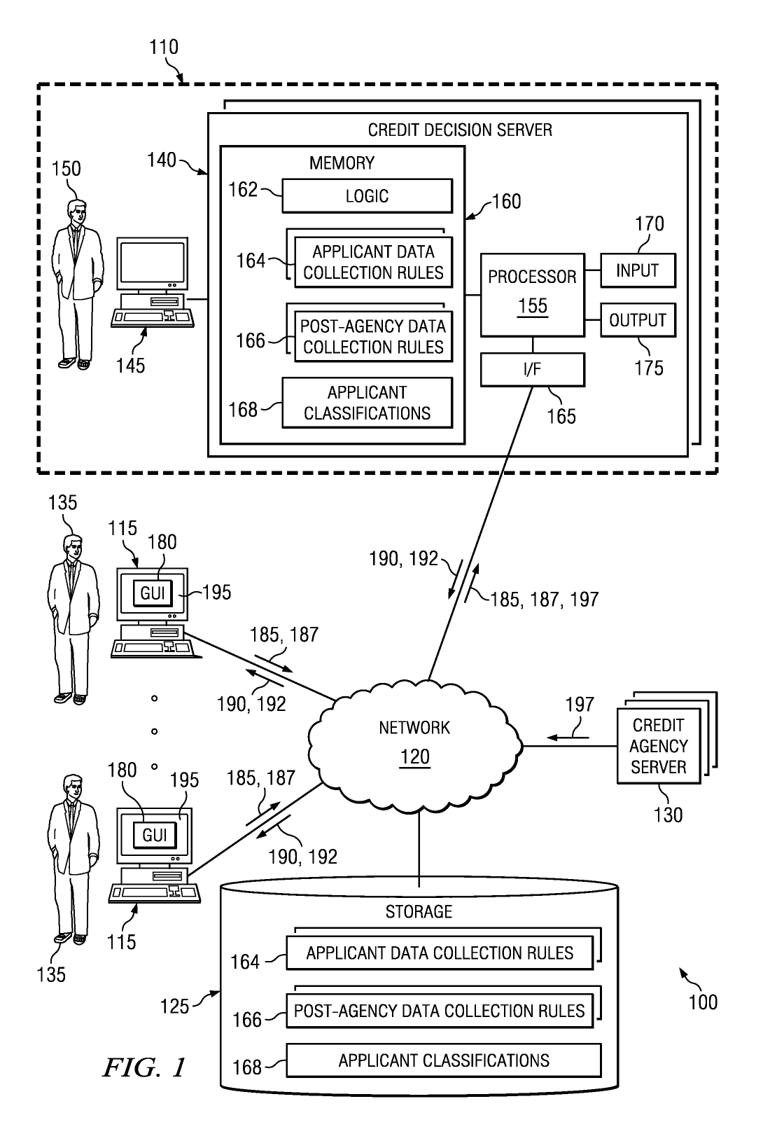

Embodiments of the present disclosure and their advantages are best understood by referring to FIGS. 1 through 8 of the drawings, like numerals being used for like and corresponding parts of the various drawings.

FIG. 1 illustrates an example system 100 for processing a credit application, according to certain embodiments of the present disclosure. In general, processing of a credit application is used by any entity that extends credit. For example, an entity such as an enterprise may decide whether to extend credit to a particular applicant based on the processing of a credit application completed by the applicant. In particular, system 100 may include an enterprise 110, one or more clients 115, a network storage device 125, one or more credit agency servers 130, one or more credit decision servers 140, and one or more users 135. Enterprise 110, clients 115, network storage device 125, and credit agency servers 130 may be communicatively coupled by a network 120. Enterprise 110 is generally operable to process credit applications for users 135 as described below.

In general, one or more credit decision servers 140 process credit applications for users 135. User 135 may be seeking credit from a credit entity, such as enterprise 110. User 135 may provide a credit application request 185 to credit decision server 140 by utilizing client 115. Credit decision server 140 may then transmit one or more applicant data requests 190 to user 135, according to credit application request 185 provided by user 135. In response, user 135 may provide one or more applicant data responses 187. Applicant data responses may refer to any information about the applicant, such as user 135, that may assist the credit entity in determining whether to extend credit to the applicant. Credit decision server 140 may use the credit application request 185 and/or the applicant data responses 187 to classify the applicant. Depending on the classification and the applicant data responses 187, credit decision server 140 may customize requests for additional applicant data. Accordingly, credit decision server 140 may transmit one or more additional applicant data requests 190 to user 135 and receive in response one or more applicant data responses 187. Credit decision server 140 may then receive applicant credit information 197 from one or more credit agency servers 130. Depending on the applicant credit information 197 and the applicant data responses 187, credit decision server 140 may determine whether to request post-agency applicant data by transmitting one or more applicant data requests 190 to user 135. Based on the applicant credit information 197 and the applicant data responses 187, credit decision server 140 may then determine whether the credit entity should extend credit to the applicant, and transmit an appropriate credit decision 192 to user 135 accordingly.

In the interest of clarity, the remainder of this disclosure assumes that the user 135 is the applicant, and the enterprise 110 is the credit entity. However, it should be understood that the present disclosure is not limited to this scenario. The user 135 may be any suitable user with any suitable relationship to the applicant. For example, user 135 may be an employee or contractor of enterprise 110, or a person who acts on behalf of the applicant. Likewise, enterprise 110 may be a subdivision or contractor of the credit entity, or otherwise process credit applications on behalf of the credit entity.

Client 115 may refer to any device that enables user 135 to interact with credit decision server 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface such as a display 195, microphone, keyboard, or any other appropriate terminal equipment usable by a user 135. It will be understood that system 100 may comprise any number and combination of clients 115. Client 115 may be utilized by user 135 to interact with credit decision server 140 in order to complete a credit application, as described below.

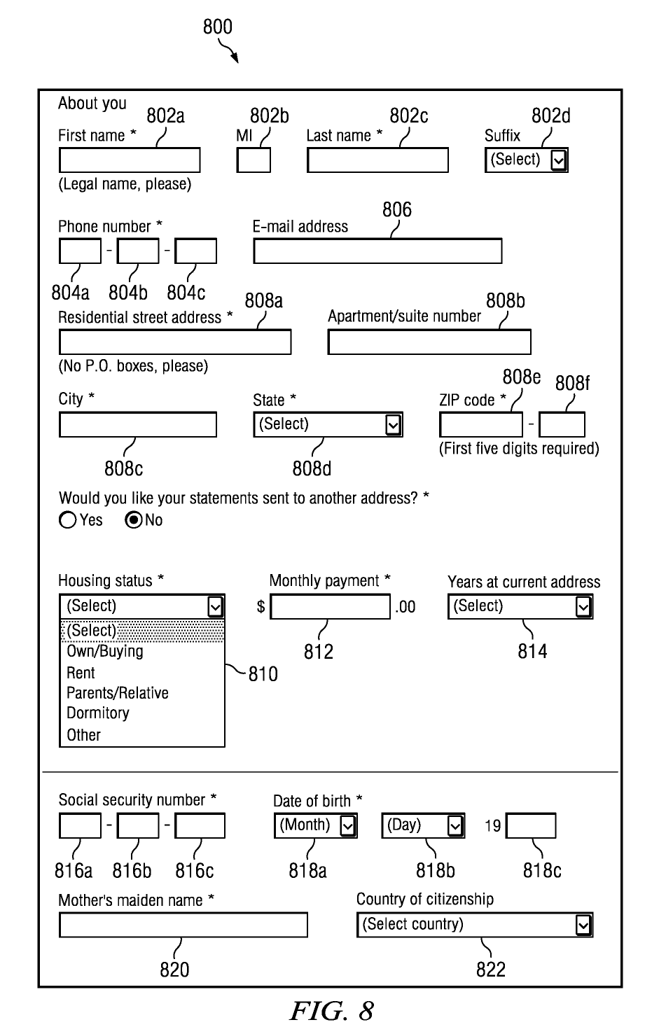

In some embodiments, client 115 may include a graphical user interface (GUI) 180. GUI 180 is generally operable to tailor and filter data presented to user 135. GUI 180 may provide user 135 with an efficient and user-friendly presentation of applicant data requests 190 and credit decisions 192. GUI 180 may additionally provide user 135 with an efficient and user-friendly way of inputting and submitting credit application requests 185 and applicant data responses 187. GUI 180 may comprise a plurality of displays having interactive fields, pull-down lists, and buttons operated by user. GUI 180 may include multiple levels of abstraction including groupings and boundaries. It should be understood that the term graphical user interface 180 may be used in the singular or in the plural to describe one or more graphical user interfaces 180 and each of the displays of a particular graphical user interface 180. An example screenshot according to one embodiment of GUI 180 is described in more detail below in connection with FIG. 8.

In some embodiments, network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. In certain embodiments, network storage device 125 may be a SQL Server database.

In some embodiments, credit agency servers 130 may include any suitable server communicatively coupled to network 120 and capable of delivering applicant credit information 197 to credit decision server 140. In some embodiments, credit agency server 130 may be a web server that provides credit reports, credit history, and/or credit scores from one or more consumer credit reporting agencies, such as EXPERIAN, EQUIFAX, TRANSUNION, and INNOVIS, among others.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank or other credit entity and may include one or more credit decision servers 140, an administrator workstation 145, and an administrator 150. In some embodiments, credit decision server 140 may refer to any suitable combination of hardware and/or software implemented in one or more modules to process data and provide the described functions and operations. In some embodiments, the functions and operations described herein may be performed by a pool of credit decision servers 140. In some embodiments, credit decision server 140 may include, for example, a mainframe, server, host computer, workstation, web server, file server, a personal computer such as a laptop, or any other suitable device operable to process data. In some embodiments, credit decision server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. In some embodiments, credit decision server 140 may be a web server running Microsoft's Internet Information Server™.

In general, credit decision server 140 processes credit application requests 185 for users 135. In some embodiments, credit decision servers 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile computer-readable memory devices that store one or more files, lists, tables, or other arrangements of information. Although FIG. 1 illustrates server memory 160 as internal to credit decision server 140, it should be understood that server memory 160 may be internal or external to credit decision server 140, depending on particular implementations. Also, server memory 160 may be separate from or integral to other memory devices to achieve any suitable arrangement of memory devices for use in system 100.

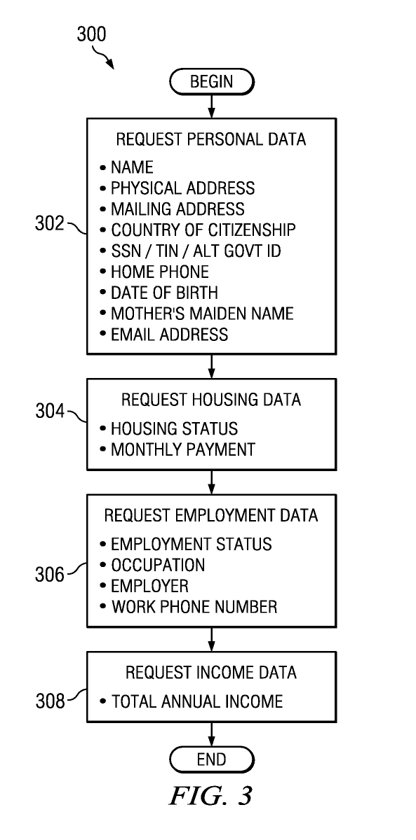

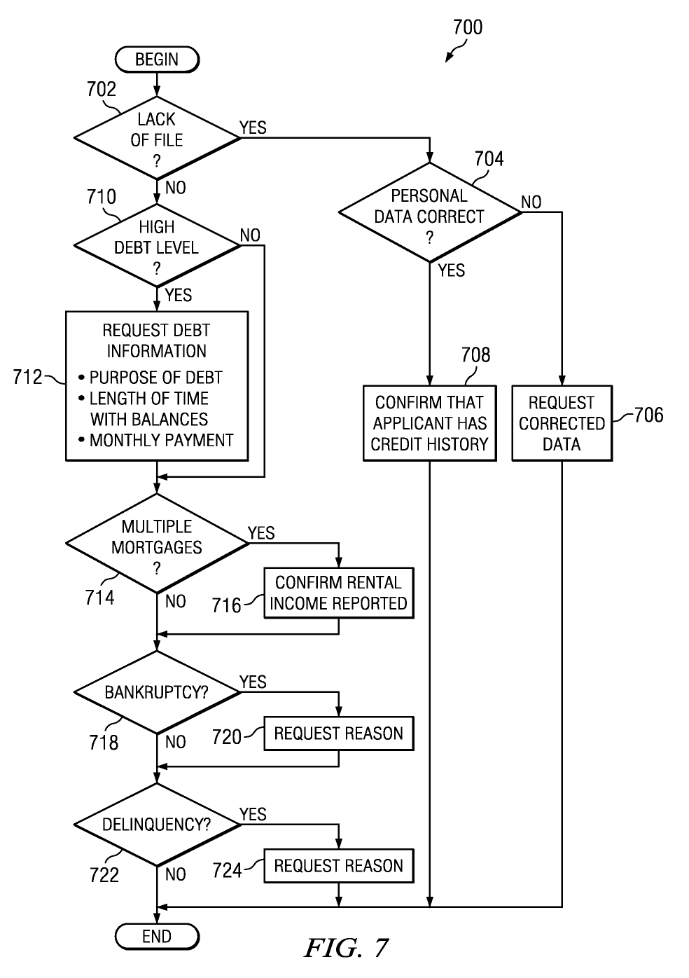

Server memory 160 is generally operable to store logic 162, applicant data collection rules 164, post-agency data collection rules 166, and applicant classifications 168. Logic 162 generally refers to logic, rules, algorithms, code, tables, and/or other suitable instructions for performing the described functions and operations. Applicant data collection rules 164 may be any collection of rules, standards, policies, limitations, and/or any number and combination of suitable guidelines regarding the collection of applicant data. In general, applicant data collection rules 164 may allow credit decision server 140 to customize requests for additional applicant data based on applicant data responses 187. Example methods utilizing particular embodiments of data collection rules 164 are described in more detail below in connection with FIGS. 3, 4, 5A-5B, and 6A-6B. Post-agency data collection rules 166 may be any collection of rules, standards, policies, limitations, and/or any number and combination of suitable guidelines regarding the collection of applicant data following receipt of applicant credit information 197 from credit agency server 130. In general, post-agency data collection rules 166 may allow credit decision server 140 to determine whether to request post-agency applicant data from user 135. An example method utilizing particular embodiments of post-agency data collection rules 166 is described in more detail below in connection with FIG. 7. Applicant classifications 168 may include any list of applicable applicant classifications that may be used by enterprise 110 to categorize a credit applicant, such as user 135. Applicant classifications 168 may include a preferred classification, a credit builder classification, a non-relationship classification, a student classification, or any other suitable classification. In certain embodiments, applicant classifications 168 may also include any collection of rules, standards, policies, limitations, and/or any number and combination of suitable guidelines for determining an applicant classification for a particular credit application.

Server memory 160 is communicatively coupled to processor 155. Processor 155 is generally operable to execute logic 162 stored in server memory 160 to process credit applications according to the disclosure. Processor 155 may include one or more microprocessors, controllers, or any other suitable computing devices or resources. Processor 155 may work, either alone or with components of system 100, to provide a portion or all of the functionality of system 100 described herein. In some embodiments, processor 155 may include, for example, any type of central processing unit (CPU).

In some embodiments, communication interface 165 (I/F) is communicatively coupled to processor 155 and may refer to any suitable device operable to receive input for credit decision server 140, send output from credit decision server 140, perform suitable processing of the input or output or both, communicate to other devices, or any combination of the preceding. Communication interface 165 may include appropriate hardware (e.g. modem, network interface card, etc.) and software, including protocol conversion and data processing capabilities, to communicate through a LAN, WAN, or other communication system that allows credit decision server 140 to communicate to other devices. Communication interface 165 may include any suitable software operable to access data from various devices such as clients 115, network storage device 125, and/or credit agency servers 130. Communication interface 165 may also include any suitable software operable to transmit data to various devices such as clients 115, network storage device 125, and/or credit agency servers 130. Communication interface 165 may include one or more ports, conversion software, or both.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, administrator 150 may interact with credit decision server 140 using an administrator workstation 145. In some embodiments, administrator workstation 145 may be communicatively coupled to credit decision server 140 and may refer to any suitable computing system, workstation, personal computer such as a laptop, or any other device operable to process data. In certain embodiments, an administrator 150 may utilize administrator workstation 145 to manage credit decision server 140 and any of the data stored in server memory 160 and/or network storage device 125.

In operation, logic 162, when executed by processor 155, processes credit applications for users 135. To process credit applications, logic 162 may first receive credit application requests 185 from users 135 via clients 115. A credit application request 185 may include a product selection, indicating the credit product that the applicant is interested in applying for. A credit application request 185 may also include relationship information, such as whether user 135 has any other accounts with or existing credit products from enterprise 110. Logic 162 may use the relationship information to determine a relationship strength between user 135 and enterprise 110. For example, logic 162 may access account information associated with user 135 and assign a numerical score to the relationship based on factors such as the following: number of accounts and/or credit products, account balances, credit limits, length of time accounts have been open, whether accounts are in good standing, and/or any other suitable information.

Logic 162 may then transmit one or more applicant data requests 190 to user 135. In response, user 135 may provide one or more applicant data responses 187. In some embodiments, the applicant data requests 190 may include requests for personal data. Applicant data responses 187 may include such information as applicant's name, physical address, mailing address, country of citizenship, social security number/taxpayer identification number/alternate government identification, home phone, date of birth, mother's maiden name, email address, any other suitable information, and/or any suitable combinations of the foregoing. In certain embodiments, the applicant data requests 190 may also include requests directed to whether the applicant is a student, and the applicant data responses 187 may include a student indicator, accordingly.

Logic 162 may use applicant classifications 168 to classify the applicant. In certain embodiments, logic 162 may determine the applicant classification based on the product selection (from credit application request 185), the relationship strength (determined as described above), and/or the student indicator (from applicant data responses 187). For example, logic 162 may determine that the applicant classification is a student classification if the student indicator indicates that the applicant is a student, or if the product selection is a student credit product. As another example, logic 162 may determine that the applicant classification is a preferred classification if the relationship strength is sufficiently strong (e.g. if the numerical score is greater than a configurable threshold). As another example, logic 162 may determine that the applicant classification is a credit builder classification if the product selection is a secured credit product (such as a secured credit card, which may utilize a cash deposit as collateral for the credit account). As another example, logic 162 may determine that the applicant classification is a non-relationship classification if user 135 has no relationship with enterprise 110, or if the relationship strength is relatively weak (e.g. if the numerical score is less than a configurable threshold). In some embodiments, logic 162 may use the non-relationship classification as a default classification.

Logic 162 may dynamically determine additional applicant data to request from user 135 based on received applicant data responses 187. In some embodiments, logic 162 may utilize applicant data collection rules 164 for this purpose. Based on the applicant classification, logic 162 may determine one or more collection rules from applicant data collection rules 164. Logic 162 may then utilize the one or more collection rules to customize requests for additional applicant data using the determined collection rules. The customized requests for additional applicant data may be used to collect additional information from user 135 by transmitting applicant data requests 190 and receiving in response applicant data responses 187.

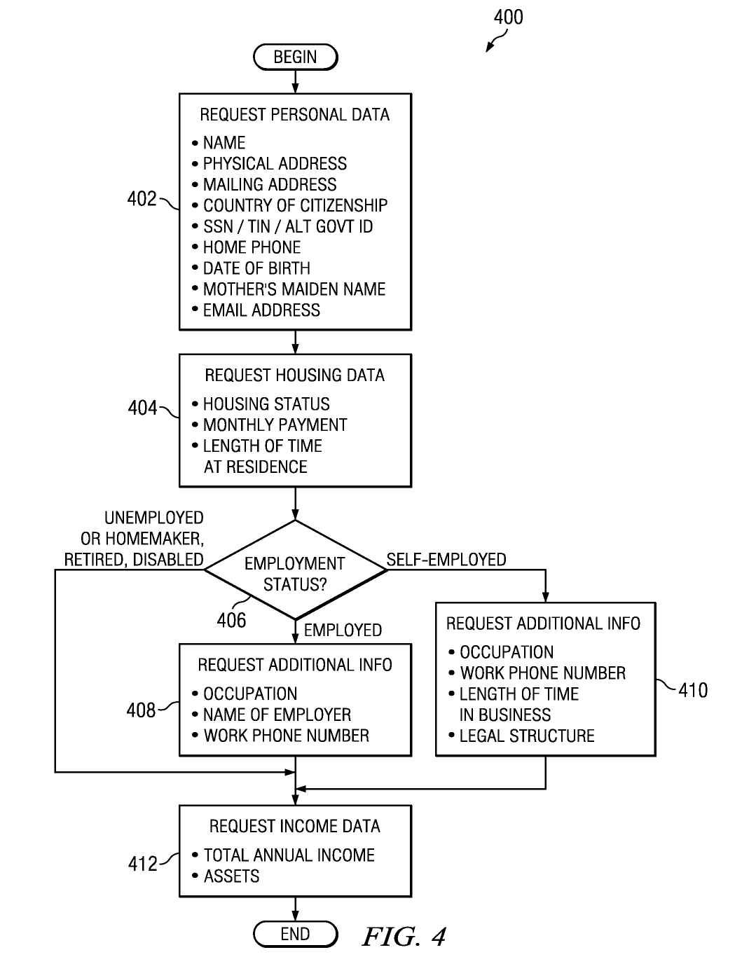

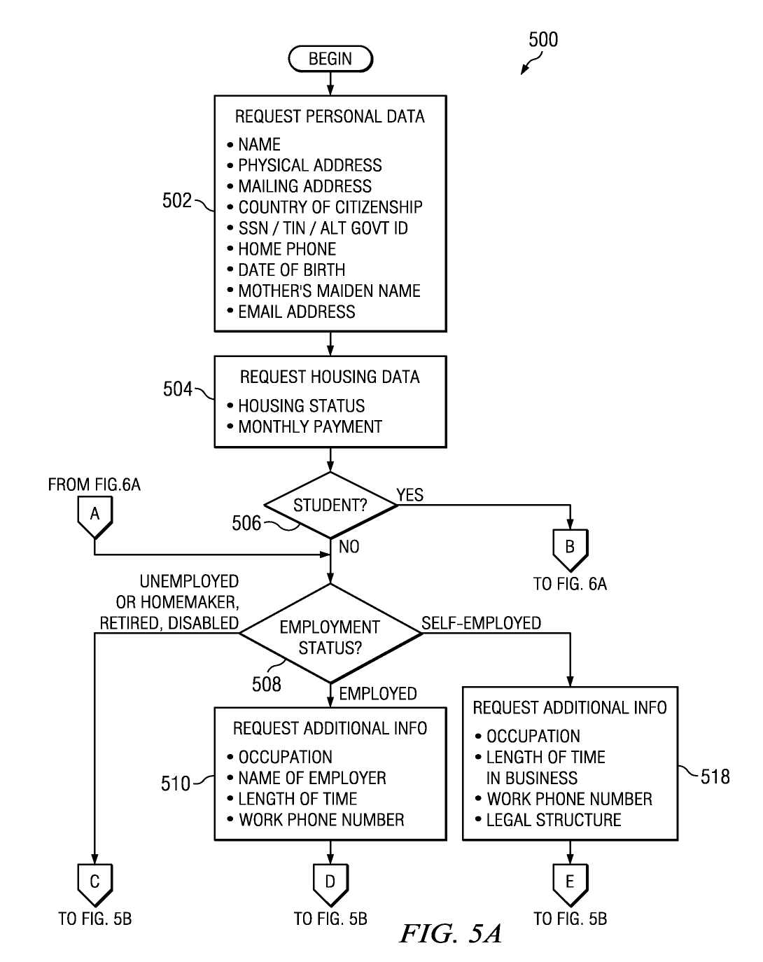

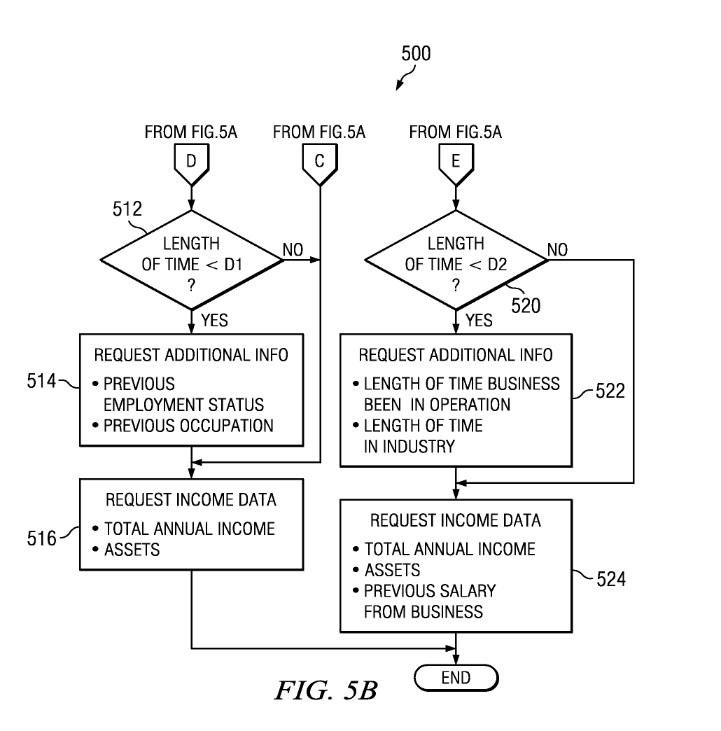

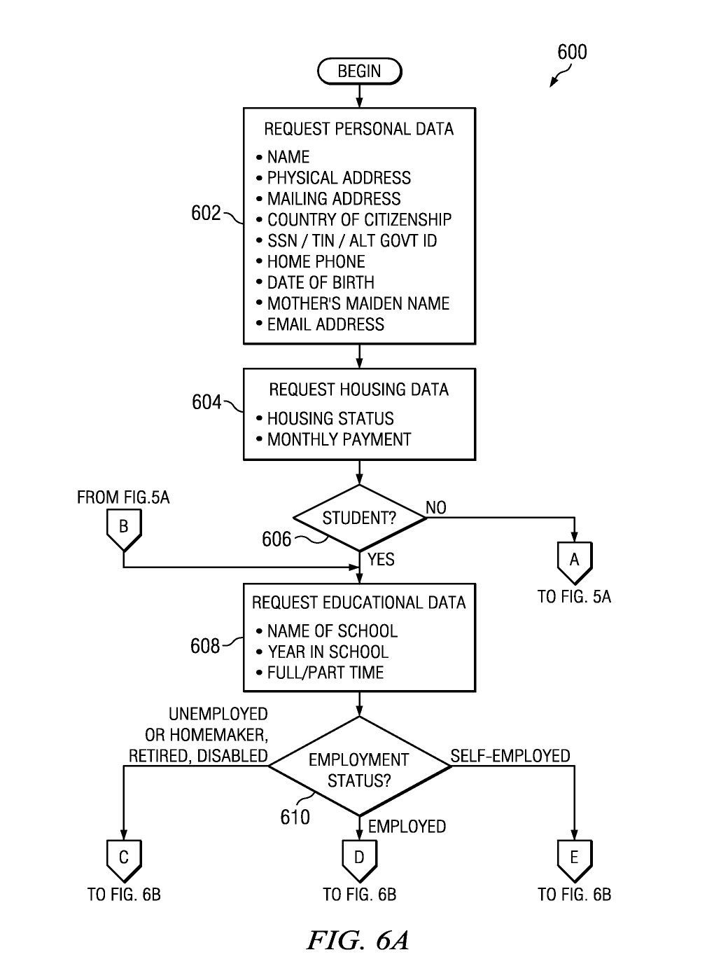

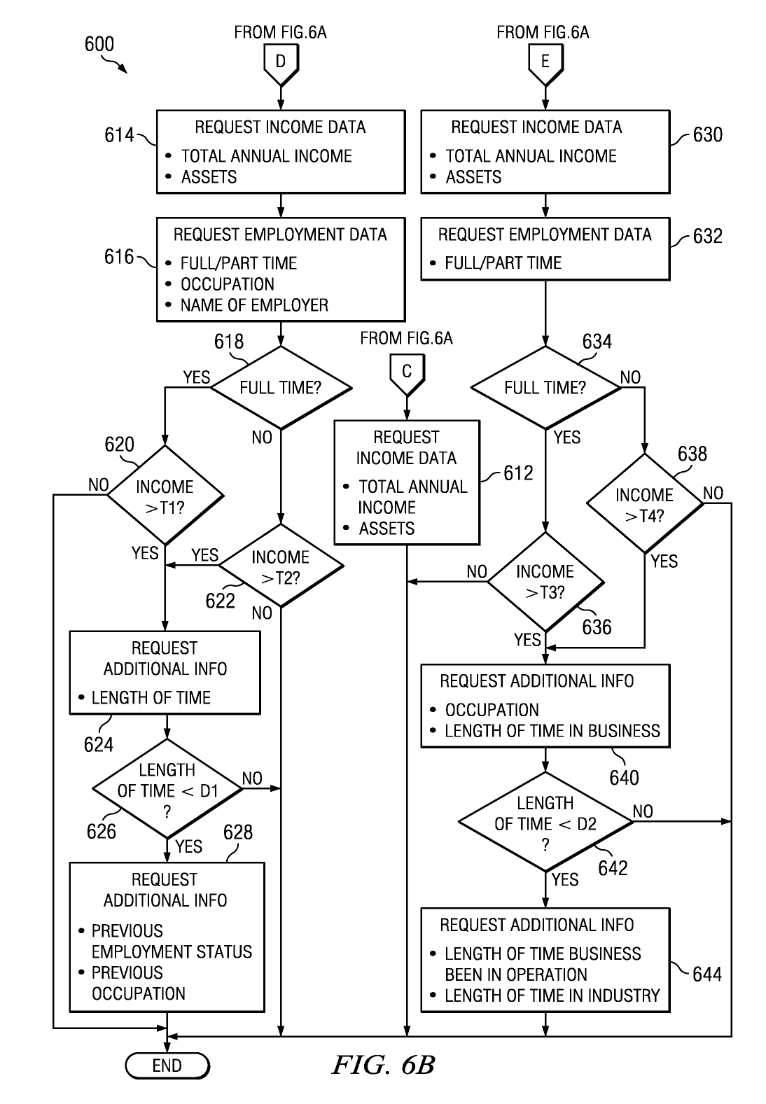

In certain embodiments, if the applicant classification is a preferred classification, logic 162 may determine a first set of collection rules from applicant data collection rules 164. An example method utilizing a particular embodiment of the first set of collection rules is described in more detail below in connection with FIG. 3. If the applicant classification is a credit builder classification, logic 162 may determine a second set of collection rules from applicant data collection rules 164. An example method utilizing a particular embodiment of the second set of collection rules is described in more detail below in connection with FIG. 4. If the applicant classification is a non-relationship classification, logic 162 may determine a third set of collection rules from application data collection rules 164. An example method utilizing a particular embodiment of the third set of collection rules is described in more detail below in connection with FIGS. 5A-5B. If the applicant classification is a student classification, logic 162 may determine a fourth set of collection rules from applicant data collection rules 164. An example method utilizing a particular embodiment of the fourth set of collection rules is described in more detail below in connection with FIGS. 6A-6B.

Once the customized requests for additional applicant data have been used to collect additional information from user 135, logic 162 may then receive applicant credit information 197 from one or more credit agency servers 130. Based on applicant data responses 187 and applicant credit information 197, logic 162 may make an initial determination of whether to extend credit to the applicant. In certain embodiments the initial determination may be to approve the application, to decline the application, or to refer the application to a credit analyst for further review. Logic 162 may determine whether requesting further information from the applicant would facilitate an automatic decision on the application. Logic 162 may utilize post agency data collection rules 166 for this purpose. Based on credit information 197, logic 162 may determine one or more post-agency rules from the post-agency data collection rules 166. Logic 162 may then utilize the one or more post-agency rules to determine whether to request post-agency applicant data. For example, if applicant credit information 197 received from credit agency server 130 indicates a credit search failure, such as where a credit file cannot be located for the applicant, logic 162 may request additional personal data. For example, logic 162 may confirm that the personal data was captured correctly and may confirm that applicant has a credit history in the United States. As another example, if applicant credit information 197 indicates a high debt level, logic 162 may request debt information from user 135. In some embodiments this may be accomplished by comparing the debt level to a first debt threshold, which may be configured to any suitable amount. As another example, if applicant credit information 197 indicates a negative credit event, such as a bankruptcy or a delinquency, logic 162 may request explanatory information from user 135. An example method utilizing particular embodiments of post-agency data collection rules 166 is described in more detail below in connection with FIG. 7. In general logic 162 may request post-agency applicant data from user 135 by transmitting one or more applicant data requests 190 and receiving in response applicant data responses 187.

Based on the applicant credit information 197 and the applicant data responses 187, including any responses received in response to requests for post-agency applicant data, logic 162 may then determine whether the credit entity should extend credit to the applicant and transmit an appropriate credit decision 192 to user 135 accordingly.

In some embodiments, logic 162 may perform an analysis to determine the effectiveness or desirability of particular applicant data requests 190 (or combinations of requests) that are presented to user 135. For example, logic 162 may assign a numerical score to each applicant data request 190. This analysis may be utilized to update and/or refine applicant data collection rules 164 and/or post-agency data collection rules 166 (for example, based on the assigned numerical scores). As an example, the analysis may include statistical analysis of a relatively large sample of applications completed by multiple users 135. In performing this analysis, logic 162 may take into account the particular applicant data requests 190 that were customized for user 135, a completion metric, an approval metric, an automation metric, a response metric, and/or any other suitable metric. A completion metric may reflect the rate at which users 135 in the sample successfully completed the application process, or particular portions thereof. An approval metric may reflect the rate at which users 135 in the sample had their credit applications approved. An automation metric may reflect the rate at which users 135 were able to obtain a decision without the need for a referral to a credit analyst (i.e. logic 162 was able to make a credit decision automatically). A response metric may reflect the rate at which users 135 responded to particular applicant data requests 190 (such as requests where a response was optional but not required).

Particular embodiments of the present disclosure may provide some, none, or all of the following technical advantages. By customizing requests for applicant information, certain embodiments may prevent applicants from being asked unnecessary questions. By eliminating the need for unnecessary questions, some embodiments may increase the number of completed applications by reducing the number of applicants who begin but do not complete the application process. In addition, by customizing requests for applicant information, certain embodiments may collect additional information that may reflect favorably on the applicant, which may increase the percentage of applications that are approved. Moreover, by customizing requests for applicant information, certain embodiments may collect additional information that may reflect unfavorably on the applicant, which may allow the credit entity to have a clearer picture of the risk associated with extending credit to the applicant. Certain embodiments may also increase efficiency of credit application processing and reduce the need for human labor. For example, by providing for the possibility of requesting post-agency applicant data, certain embodiments may reduce the number of applications that may need to be reviewed by a credit analyst.

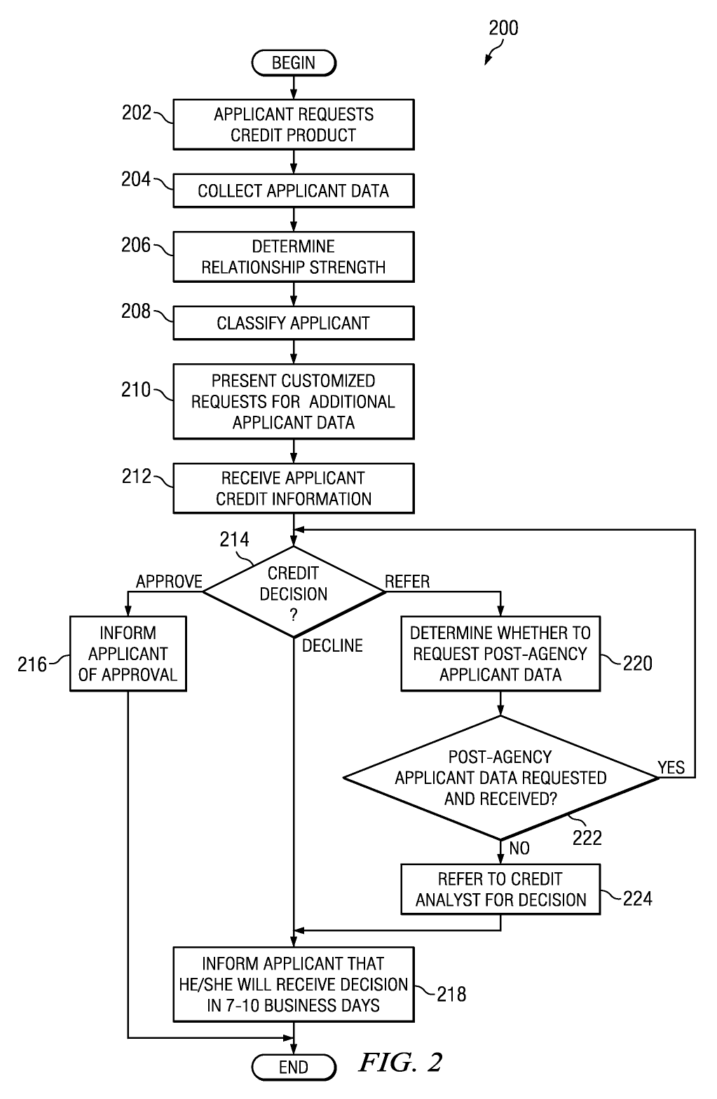

FIG. 2 illustrates an example method 200 for processing a credit application, according to certain embodiments of the present disclosure. The example method of FIG. 2 may be performed by example system 100 of FIG. 1 according to certain embodiments of the present disclosure. The method may be implemented in any suitable combination of software, firmware, and hardware.

Although particular components may be identified as performing particular steps, the present disclosure contemplates any suitable components performing the steps according to particular needs.

The example method begins at step 202, in which an applicant requests a credit product. User 135 may submit a credit application request 185 to credit decision server 140. Credit application request 185 may include a product selection. In some embodiments, a product selection may be a consumer credit card product. For example, the product selection may be a consumer credit card product, a student credit card product, a secured credit card product, or any other suitable product. At step 204 applicant data is collected. Credit decision server 140 may submit one or more applicant data requests 190 to user 135 and receive in response one or more applicant data responses 187. In some embodiments, credit decision server 140 may collect sufficient applicant data to allow credit decision server 140 to classify the applicant. In some embodiments, the applicant data requests 190 may include requests for personal data. Applicant data responses 187 may include such information as applicant's name, physical address, mailing address, country of citizenship, social security number/taxpayer number/alternate government identification, home phone number, date of birth, mother's maiden name, email address, any other suitable information and/or any suitable combination of the foregoing. In certain embodiments, the applicant data requests 190 may also include requests directed to whether the applicant is a student and the applicant data responses 187 may include a student indicator, accordingly. In certain embodiments, applicant data requests 190 may include requests for relationship information such as whether user 135 has any other accounts with or existing credit products from enterprise 110. In certain other embodiments, this information may be collected earlier, such as in the credit application request 185. In certain other embodiments, credit decision server 140 may determine relationship information based on the collected personal information by accessing information about user 135's accounts with the credit entity. Although the collection of particular applicant data is described, this disclosure contemplates collection of any suitable applicant data according to particular needs.

At step 206 a relationship strength may be determined. Credit decision server 140 may determine the relationship strength between user 135 and enterprise 110 based on the collected relationship information. For example, credit decision server 140 may access account information associated with user 135 and assign a numerical score to the relationship based on factors such as the following: number of accounts and/or credit products, account balances, credit limits, length of time accounts have been open, whether accounts are in good standing, any other suitable information, and/or any suitable combination of the foregoing. Credit decision server 140 may assign a high relationship strength where user 135 has a strong relationship with enterprise 110. Credit decision server 140 may assign a low relationship strength where user 135 has little or no relationship with enterprise 110.

At step 208 the applicant may be classified. Credit decision server 140 may use applicant classifications 168 to classify the applicant. In certain embodiments, credit decision server 140 may determine the applicant classification based on the product selection, the relationship strength, and/or the student indicator. For example, credit decision server 140 may determine that the applicant classification is a student classification, if the student indicator indicates that the applicant is a student, or if the product selection is a student credit product. As another example, credit decision server 140 may determine that the applicant classification is a preferred classification if the relationship strength is sufficiently strong (e.g., if the numerical score is greater than a configurable threshold). As another example, credit decision server 140 may determine that the applicant classification is a credit builder classification if the product selection is a secured credit product, such as a secured credit card which may utilize a cash deposit as collateral for the credit account. As another example, credit decision server 140 may determine that the applicant classification is a non-relationship classification if user 135 has no relationship with enterprise 110 or if the relationship strength is weaker, e.g., if the numerical score is less than a configurable threshold. In some embodiments, credit decision server 140 may use the non-relationship classification as a default classification.

At step 210 customized requests for additional applicant data may be presented. Credit decision server 140 may dynamically determine additional applicant data to request from user 135 based on the received applicant data responses 187. In some embodiments, credit decision server 140 may utilize applicant data collection rules 164 for this purpose. Based on the applicant classification, credit decision server 140 may determine one or more collection rules from applicant data collection rules 164. Credit decision server 140 may then utilize the one or more collection rules to customize requests for additional applicant data using the determined collection rules. The customized requests for additional applicant data may be used to collect additional information from user 135 by transmitting applicant data requests 190 and receiving in response applicant data responses 187. Customized requests for additional applicant data may facilitate collection of further information where previous responses and information about the applicant indicate that additional information may be useful in order to make a credit decision on the application. Customized requests for additional applicant data may also facilitate avoiding asking for further information where a credit decision can be made without the collection of additional information. For example, where user 135 has a strong relationship with enterprise 110 it may be unnecessary to request extensive data from user 135. As another example, it may be desirable to collect different types of information from user 135 depending on the employment status of user 135. For instance, if the employment status indicates that user 135 is unemployed, it may be unnecessary to collect employment information. As another example, it may be desirable to collect additional information from user 135 if the length of time at user 135's current job is relatively short. For instance, additional information about user 135's previous employment status may be collected. As another example, if user 135 is a student, user 135's job may have little impact on the final credit decision.

Therefore, it may be desirable not to collect additional information about the student's job if the income is relatively low. This disclosure contemplates any suitable customized requests for additional applicant data according to particular needs.

At step 212 applicant credit information may be received. Credit decision server 140 may receive applicant credit information 197 from credit agency server 130. Applicant credit information 197 may provide information about the applicant's credit history such as a credit score, a credit report, or any other suitable information.

At step 214 a credit decision may be made. Credit decision server 140 may make an initial determination based on applicant data responses 187 and applicant credit information 197. In some embodiments, the initial determination may be to approve, to decline, or to refer the decision to a credit analyst. In some embodiments, an initial determination to approve may indicate that enterprise 110 should extend credit to user 135. If the initial determination is to approve, the method proceeds to step 216 where the applicant is informed of approval. Credit decision server 140 may transmit credit decision 192 to user 135. The method then ends.

An initial determination to decline may indicate that enterprise 110 should not extend credit to user 135. If the initial determination is to decline, the method proceeds to step 218 where an applicant may be informed that he or she will receive a decision in seven to ten business days. Credit decision server 140 may transmit credit decision 192 to user 135. In certain other embodiments, user 135 may immediately be informed that the application has been declined. The method then ends.

An initial determination to refer may indicate that a decision to approve or to decline may not be made automatically based on the information currently available. If the initial determination is to refer, the method proceeds to step 220. At step 220 credit decision server 140 may determine whether to request post-agency applicant data. In some embodiments, credit decision server 140 may determine one or more post-agency rules from post-agency data collection rules 166 based on applicant credit information 197. Credit decision server 140 may then determine whether to request post-agency applicant data based on the determined one or more post-agency rules. For example, credit decision server 140 may request post-agency applicant data if applicant credit information 197 indicates a credit search failure such as where a credit history or credit score cannot be located for user 135. Credit decision server 140 may then verify the accuracy of the personal information that has been collected and request any corrections as appropriate. Credit decision server 140 may also verify that user 135 has a credit history in the United States. As another example, if applicant credit information 197 indicates a high debt level, credit decision server 140 may request debt information. As another example, if applicant credit information 197 indicates a negative credit event such as a bankruptcy or a delinquency, credit decision server 140 may request explanatory information. In some embodiments, credit decision server 140 may indicate that responses to the requests for post-agency applicant data are optional and that user 135 may choose to respond to them in order to expedite processing of the application but may also allow user 135 to choose not to respond to the requests for post-agency applicant data.

At step 222 if post-agency applicant data has been requested and received, (e.g., user 135 submits applicant data responses 187 in response to one or more applicant data requests 190) the method returns to step 214 where an updated credit decision may be made based on the additional information. On the other hand, if post-agency applicant data is not requested, (e.g., credit decision server 140 determines not to request post-agency applicant data or user 135 declines to respond to requests for post-agency applicant data) the method proceeds to step 224 where the application is referred to a credit analyst for decision. The method then proceeds to step 218 where applicant is informed that he or she will receive a decision in seven to ten business days. Credit decision server 140 may transmit credit decision 192 to user 135. The method then ends.

FIG. 3 illustrates an example method 300 for collecting applicant information in connection with a credit application, according to certain embodiments of the present disclosure. The example method of FIG. 3 may be performed by example system 100 of FIG. 1 according to certain embodiments of the present disclosure. The method may be implemented in any suitable combination of software, firmware, and hardware. Although particular components may be identified as performing particular steps, the present disclosure contemplates any suitable components performing the steps according to particular needs.

Method 300 represents an example method for collecting applicant information that may be utilized when the applicant classification is a preferred classification and/or the determined one or more collection rules are a first set of collection rules. The example method begins at step 302, in which personal data is requested. Credit decision server 140 may request personal data from user 135 using one or more applicant data requests 190 and receiving in response one or more applicant data responses 187. Personal data may include applicant's name, physical address, mailing address, country of citizenship, social security number/taxpayer identification number/alternate government identification, home phone number, date of birth, mother's maiden name, email address, other suitable information, and/or any combination of the foregoing. At step 304 housing data is requested. Credit decision server 140 may request housing data from user 135 using one or more applicant data requests 190 and receiving in response one or more applicant data responses 187. Housing data may include housing status, monthly housing payment, other suitable data, and/or any combination of the foregoing. As an example, housing status may include own, rent, or other. A housing status of own may indicate that user 135 owns his or her place of residence. A housing status of rent may indicate that user 135 rents his or her place of residence. The monthly payment may represent a monthly rent to be paid or a monthly mortgage payment. In certain embodiments, housing payment information may be collected on an annual basis rather than a monthly basis, or on any other suitable basis.

At step 306 employment data is requested. Credit decision server 140 may request employment data by transmitting one or more applicant data requests 190 and receiving in response one or more applicant data responses 187. Employment data may include applicant's employment status, occupation, employer, work phone number, other suitable information, and/or any combination of the foregoing. At step 308 income data is requested. Credit decision server 140 may transmit one or more applicant data requests 190 to user 135 and receive in response one or more applicant data responses 187. Income data may include total annual income or any other suitable information about applicant's income. The method then ends.

FIG. 4 illustrates another example method 400 for collecting applicant information in connection with a credit application, according to certain embodiments of the present disclosure. The example method of FIG. 4 may be performed by example system 100 of FIG. 1 according to certain embodiments of the present disclosure. The method may be implemented in any suitable combination of software, firmware, and hardware. Although particular components may be identified as performing particular steps, the present disclosure contemplates any suitable components performing the steps according to particular needs.

Method 400 represents an example method for collecting applicant information that may be utilized when the applicant classification is a credit builder classification and/or the determined one or more collection rules are a second set of collection rules. The example method begins at step 402, in which personal data is requested. Credit decision server 140 may request personal data from user 135 by transmitting one or more applicant data requests to user 135 and receiving in response one or more applicant data responses 187. Personal data may include applicant's name, physical address, mailing address, country of citizenship, social security number/taxpayer identification number/alternate government identification, home phone, date of birth, mother's maiden name, email address, other suitable information, and/or any combination of the foregoing. At step 404 housing data is requested. Credit decision server 140 may request housing data from user 135 by transmitting one or more applicant data requests 190 to user 135 and receiving in response one or more applicant data responses 187. Housing data may include applicant's housing status, monthly payment, length of time at residence, other suitable housing information, or any combination of the foregoing. Housing status may include own (indicating that applicant owns his or her place of residence), rent (indicating applicant rents his or her place of residence), or other. In some embodiments, housing payment information may be collected on a basis other than a monthly basis, such as an annual basis or any other suitable basis.

At step 406 applicant's employment status is determined. Credit decision server 140 may request the employment status of user 135 using one or more applicant data requests 190 and receiving in response one or more applicant data responses 187. Employment status may include an employed status, self-employed status, an unemployed status, a homemaker status, a retired status, a disabled status, or any other suitable status. In some embodiments, an unemployed status may include a homemaker status, a retired status, and/or a disabled status. If the applicant's employment status is determined to an unemployed status, a homemaker status, a retired status, or a disabled status, the method proceeds to step 412.

If applicant's employment status is determined to be an employed status, the method proceeds to step 408 in which additional information is requested. The additional information may be requested by credit decision server 140 by transmitting one or more applicant data requests 190 to user 135 and receiving in response one or more applicant data responses 187. The additional information requested may include applicant's occupation, applicant employer data, other suitable information, and/or any combination of the foregoing. Employer data may include information such as the name of applicant's employer, a work phone number, other suitable information and/or any combination of the foregoing. The method then proceeds to step 412.

If the applicant's employment status is determined to be a self-employed status, the method proceeds to step 410. At step 410 additional information is requested. Credit decision server 140 may request additional information from user 135 by transmitting one or more applicant data requests 190 to user 135 and receiving in response one or more applicant data responses 187. The additional information requested may include applicant's occupation, work phone number, business history data, other suitable information, and/or any combination of the foregoing. Business history data may include length of time in business which may indicate the time a self-employed applicant has been in business. Business history data may also include the legal structure of applicant's business. The legal structure may include sole proprietorship, partnership, limited liability company (LLC), or any other appropriate structure. The method then proceeds to step 412.

At step 412 income data is requested. Credit decision server 140 may request income data from user 135 by transmitting one or more applicant data requests 190 and receiving in response one or more applicant data responses 187. Income data may include total annual income, assets, any other suitable information about applicant's income, and/or any combination of the foregoing. In some embodiments, the applicant may be asked whether he or she has assets that he would like to be included as a basis for repayment. User 135 could then provide asset information to be considered by credit decision server 140 in making the credit decision. The method then ends.

FIGS. 5A-5B illustrate another example method 500 for collecting applicant information in connection with a credit application, according to certain embodiments of the present disclosure. The example method of FIGS. 5A-5B may be performed by example system 100 of FIG. 1 according to certain embodiments of the present disclosure. The method may be implemented in any suitable combination of software, firmware, and hardware. Although particular components may be identified as performing particular steps, the present disclosure contemplates any suitable components performing the steps according to particular needs.

Method 500 represents an example method for collecting applicant information that may be utilized when the applicant classification is a non-relationship classification and/or the determined one or more collection rules are a third set of collection rules. The example method begins at step 502, in which personal data is requested. Credit decision server 140 may request personal data from user 135 by transmitting one or more applicant data requests 190 to user 135 and receiving in response one or more applicant data responses 187. Personal data may include applicant's name, physical address, mailing address, country of citizenship, social security number/taxpayer identification number/alternate government identification, home phone number, date of birth, mother's maiden name, email address, other suitable personal information, and/or any combination of the foregoing. At step 504 housing data is requested. Credit decision server 140 may request housing data by transmitting one or more applicant data requests 190 to user 135, and receiving in response one or more applicant data responses 187. Housing data may include applicant's housing status, applicant's monthly housing payment, any other suitable housing information, and/or any combination of the foregoing. Housing status may include own (indicating that the applicant owns his or her residence), rent (indicating that the applicant rents his or her residence), or any other suitable status. In certain embodiments, housing payment information may be requested on an annual basis rather than a monthly basis, or on any other suitable basis.

At step 506 credit decision server 140 determines if the applicant is a student. This determination may be made by transmitting one or more applicant data requests 190 to user 135 and receiving in response one or more applicant data responses 187. Applicant data responses 187 may include a student indicator which indicates whether applicant is a student. If the student indicator indicates that the applicant is a student, the method proceeds to step 608 of example method 600 depicted in FIG. 6A. If the student indicator indicates that the applicant is not a student, the method proceeds to step 508 where the applicant's employment status is determined. Credit decision server 140 may determine user 135's employment status by transmitting one or more applicant data requests 190 to user 135 and receiving in response one or more data application responses 187. An employment status may include an employed status, a self-employed status, an unemployed status, a homemaker status, a retired status, a disabled status, or any other suitable status. In some embodiments, an unemployed status may include a homemaker status, a retired status and/or a disabled status. If the applicant's employment status is determined to be an unemployed status, the method proceeds to step 516 described in more detail below.

If the employment status is determined to be an employed status, the method proceeds to step 510. At step 510 additional information is requested. Credit decision server 140 may request the additional information by transmitting one or more applicant data requests 190 to user 135 and receiving in response one or more applicant data responses. The requested additional information may include the applicant's occupation and employer data. Employer data may include the name of applicant's employer, the length of time applicant has worked for the current employer, and/or a work phone number. Applicant data responses 187 may include an employment duration which may indicate the length of time applicant has worked at his or her current employer. At step 512 credit decision server 140 may determine whether the length of time applicant has worked at his or her current employer is less than a threshold duration D1. Credit decision server 140 may compare the employment duration received from user 135 to a configurable threshold duration D1. Threshold duration D1 may be configured to any suitable value. For example, threshold duration D1 may be set at two years. If credit decision server 140 determines that the employment duration is not less than the threshold duration D1, the method proceeds to step 516.

If, on the other hand, credit decision server 140 determines that the employment duration is less than the threshold duration D1, the method proceeds to step 514. At step 514 prior employment data is requested. Credit decision server 140 may request prior employment data from user 135 by transmitting one or more applicant data requests 190 and receiving in response one or more applicant data responses 187. Prior employment data may include applicant's previous employment status, applicant's previous occupation, or any other suitable information. The method then proceeds to step 516.

At step 516 income data is requested. Credit decision server 140 may request income data by transmitting one or more applicant data requests 190 to user 135 and receiving in response one or more applicant data responses 187. Income data may include applicant's total annual income, applicant's assets, or any other suitable information about applicant's income. In some embodiments, information about applicant's assets may be provided at the option of the applicant if the applicant would like them to be considered as a basis for repayment. The method then ends.

Referring back to step 508, if applicant's employment status is determined to be a self-employed status, the method proceeds to step 518 where additional information is requested. Credit decision server 140 may request additional information from user 135 by transmitting one or more applicant data requests 190 and receiving in response one or more applicant data responses 187. The requested additional information may include applicant's occupation, applicant's work phone number, business history data, or other suitable information. Business history data may include the length of time applicant has been in business. Business history data may also include the legal structure of applicant's business. The one or more applicant data responses 187 may include a business duration indicating the length of time applicant has been in business. At step 520 credit decision server 140 determines whether the length of time applicant has been in business is less than a threshold duration D2. Credit decision server 140 may compare the business duration to the threshold duration D2. The threshold duration D2 may be configured to any suitable value. For example, the threshold duration D2 may be configured to be five years. If the length of time applicant has been in business is determined not to be less than the threshold duration D2, the method proceeds to step 524.

If, on the other hand, the length of time applicant has been in business is determined to be less than second threshold duration D2, the method proceeds to step 522. At step 522 additional business history data is requested. Credit decision server 140 may request additional business history data by transmitting one or more applicant data requests 190 to user 135 in receiving in response one or more applicant data responses 187. Additional business history data may include the length of time applicant's business has been in operation, the length of time applicant has been in the industry, or any other suitable information.

At step 524 income data is requested. Credit decision server 140 may request income data from user 135 by transmitting one or more applicant data requests 190 and receiving in response one or more applicant data responses 187. Income data may include applicant's total annual income, applicant's assets, applicant's previous salary from the business, or any other suitable information. In some embodiments, the applicant may have the option whether to provide information about the applicant's assets depending on whether the applicant would like them to be included as a basis for repayment. The method then ends.

FIGS. 6A-6B illustrate another example method 600 for collecting applicant information in connection with a credit application, according to certain embodiments of the present disclosure. The example method of FIGS. 6A-6B may be performed by example system 100 of FIG. 1 according to certain embodiments of the present disclosure. The method may be implemented in any suitable combination of software, firmware, and hardware. Although particular components may be identified as performing particular steps, the present disclosure contemplates any suitable components performing the steps according to particular needs.

Method 600 represents an example method for collecting applicant information that may be utilized when the applicant classification is a student classification and/or the determined one or more collection rules are a fourth set of collection rules. The example method begins at step 602, in which personal data is requested. Credit decision server 140 may request personal data from user 135 by transmitting one or more applicant data requests 190 and receiving in response one or more applicant data responses 187. Personal data may include applicant's name, physical address, mailing address, country of citizenship, social security number/taxpayer identification number/alternate government identification, home phone number, date of birth, mother's maiden name, email address, other suitable information, and/or any combination of the foregoing. At step 604 housing data is requested. Credit decision server 140 may request housing data from user 135 by transmitting one or more applicant data requests 190 and receiving in response one or more applicant data responses 187. Housing data may include applicant's housing status, applicant's monthly housing payment, or any other suitable housing information. Housing status may include own (indicating that applicant owns his or her place of residence), rent (indicating that applicant rents his or her place of residence), or any other suitable status. In some embodiments, housing payment information may be gathered on an annual basis rather than a monthly basis, or on any other suitable basis.

At step 606 credit decision server 140 may determine whether the applicant is a student. Credit decision server 140 may make this determination by transmitting one or more applicant data requests 190 to user 135 and receiving in response one or more applicant data responses 187. Applicant data responses 187 may include a student indicator indicating whether user 135 is a student. If credit decision server 140 determines that user 135 is not a student, the method proceeds to step 508 of example method 500 described above in connection with FIG. 5A. If credit decision server 140 determines that user 135 is a student, the method proceeds to step 608 in which educational data is requested. Credit decision server 140 may request educational data by transmitting one or more applicant data requests 190 to user 135 and receiving in response one or more applicant data responses 187. Educational data may include the name of applicant's school, applicant's year in school, whether applicant is a full-time student or a part-time student, and/or any other suitable educational information.

At step 610 credit decision server 140 may determine the applicant's employment status. Credit decision server 140 may determine the employment status by transmitting one or more applicant data requests 190 to user 135 and receiving in response one or more applicant data responses 187. An employment status may include a full-time employed status, a part-time employed status, a full-time self-employed status, a part-time self-employed status, an unemployed status, a homemaker status, a retired status, a disabled status, and/or any other suitable status. In some embodiments, an unemployed status may include a homemaker status, a retired status, and/or a disabled status.

If credit decision server 140 determines that the employment status is an unemployed status, a homemaker status, a retired status, or a disabled status, the method proceeds to step 612 in which income data is requested. Credit decision server 140 may request income data from user 135 by transmitting one or more applicant data requests 190 and receiving in response one or more applicant data responses 187. Income data may include applicant's total annual income, applicant's assets, or any other suitable income information. In some embodiments, applicant may have the option of submitting information about assets if the applicant wishes them to be included as a basis for repayment. The method then ends.

If the employment status is determined to be a full-time employed status or a part-time employed status, the method proceeds to step 614 in which income data is requested. Credit decision server 140 may request income data from user 135 by transmitting one or more applicant data requests 190 and receiving in response one or more applicant data responses 187. Income data may include applicant's total annual income, applicant's assets, or any other suitable income information. Applicant data responses 187 may include a total income. The total income may represent applicant's total annual income, applicant's total annual income plus assets, or any other suitable income information. At step 616 employment data is requested. Credit decision server 140 may request employment data by transmitting one or more applicant data requests 190 to user 135 and receiving in response one or more applicant data responses 187. Employment data may include applicant's occupation, employer data, or any other suitable information. Employer data may include the name of applicant's employer. Employer data may also include whether applicant is employed full time or part time.

At step 618 credit decision server 140 determines whether applicant is employed full time. If credit decision server 140 determines that the applicant is employed full time, the method proceeds to step 620. At step 620 credit decision server 140 determines whether applicant's income is greater than income threshold T1. Credit decision server 140 may compare the total income to income threshold T1. If the total income is not greater than income threshold T1, the method ends. If the total income is greater than income threshold T1, the method proceeds to step 624.

If, on the other hand, credit decision server 140 determines that the applicant is not employed full time, the method proceeds to step 622. At step 622 credit decision server 140 determines whether applicant's total income is greater than income threshold T2. If applicant's total income is not greater than income threshold T2, the method ends. If applicant's total income is greater than income threshold T2, the method proceeds to step 624.

At step 624 additional employer data is requested. Credit decision server 140 may request additional employer data by transmitting one or more applicant data requests 190 to user 135 and receiving in response one or more applicant data responses 187. Additional employer data may include length of time applicant has been employed by the same employer or any other suitable information. Applicant data responses 187 may include an employment duration indicating the length of time applicant has worked for his or her current employer. At step 626 the employment duration may be compared to a threshold duration D1. If the employment duration is not less than the threshold duration D1, the method ends. If the employment duration is less than a threshold duration D1, the method proceeds to step 628 in which prior employment data is requested. Credit decision server 140 may request prior employment data by transmitting one or more applicant data requests 190 to user 135 and receiving in response one or more applicant data responses 187. Prior employment data may include applicant's previous employment status, applicant's previous occupation, or any other suitable information. The method then ends.

Referring back to step 610, if applicant's employment status is determined to be a full-time self-employed status or a part-time self-employed status, the method proceeds to step 630 in which income data is requested. Credit decision server 140 may request income data by transmitting one or more applicant data requests 190 to user 135 and receiving in response one or more applicant data responses 187. Income data may include applicant's total annual income, applicant's assets, or any other suitable information. Applicant data responses 187 may include a total income which may indicate applicant's total annual income, applicant's total annual income plus applicant's assets, or any other suitable measure of applicant's total income. At step 632 employer data is requested. Credit decision server 140 may request employer data by transmitting one or more applicant data requests 190 to user 135 and receiving in response one or more applicant data responses 187. Employer data may include whether applicant is employed full time or part time.

At step 634 credit decision server 140 determines whether applicant is employed full time. If applicant is employed full time, the method proceeds to step 636. At step 636 applicant's total income is compared to income threshold T3. If the total income is not greater than income threshold T3, the method ends. If the total income is greater than income threshold T3, the method proceeds to step 640.

If, on the other hand, credit decision server 140 determines that applicant is not employed full time the method proceeds to step 638. At step 638 applicant's total income is compared to income threshold T4. If applicant's total income is not greater than income threshold T4, the method ends. If applicant's total income is greater than income threshold T4, the method proceeds to step 640.

At step 640 additional information is requested. Credit decision server 140 may request additional information by transmitting one or more applicant data requests 190 to user 135 and receiving in response one or more applicant data responses 187. The additional information requested may include applicant's occupation, business history data, or other suitable information. Business history data may include the length of time the applicant has been in business. Applicant data responses 187 may include a business duration indicating the length of time applicant has been in business. At step 642 the business duration may be compared to a threshold duration D2. If credit decision server 140 determines that the business duration is not less than the threshold duration D2, the method ends. If credit decision server 140 determines that the business duration is less than threshold duration D2, the method proceeds to step 644 in which additional business history data is requested. Credit decision server 140 may request additional business history data by transmitting one or more applicant data requests 190 to user 135 and receiving in response one or more applicant data responses 187. Additional business history data may include the length of time applicant's business has been in operation, the length of time applicant has been in the industry or other suitable information. The method then ends.

FIG. 7 illustrates another example method 700 for collecting applicant information in connection with a credit application, according to certain embodiments of the present disclosure. The example method of FIG. 7 may be performed by example system 100 of FIG. 1 according to certain embodiments of the present disclosure. The method may be implemented in any suitable combination of software, firmware, and hardware. Although particular components may be identified as performing particular steps, the present disclosure contemplates any suitable components performing the steps according to particular needs.

Method 700 may represent an example method for collecting applicant information after applicant credit information 197 has been received from one or more credit agency servers 130. The example method begins at step 702. At step 702 credit decision server 140 may determine whether applicant credit information 197 indicates a credit search failure such as where the credit agency server is unable to locate a credit file or credit history for user 135. If applicant credit information 197 does not indicate a credit search failure, the method proceeds to step 710.

If applicant credit information 197 does indicate a credit search failure, the method proceeds to step 704 in which credit decision server 140 confirms that the personal data collected from applicant is correct. In some embodiments, credit decision server 140 may confirm the correctness of the collected personal data by requesting additional personal data. Credit decision server 140 may request additional personal data by transmitting one or more applicant data requests 190 to user 135 and receiving in response one or more applicant data responses 187. In some embodiments, credit decision server 140 may collect additional personal data and compare it to the earlier received personal data to find discrepancies. In other embodiments, credit decision server 140 may present the personal data received previously to user 135 and ask for confirmation that the data is correct. If credit decision server 140 determines that the data is not correct, the method proceeds to step 706 in which corrected data is requested. Credit decision server 140 may request corrected data by transmitting one or more applicant data requests 190 to user 135 and receiving in response one or more applicant data responses 187. Credit decision server 140 may then receive additional applicant credit information 197 from credit agency server 130 based on the corrected data. The method then ends.

If credit decision server 140 determines that the personal data collected earlier is correct, the method proceeds to step 708 in which credit decision server 140 confirms that the applicant has a credit history in the United States. Credit decision server 140 may confirm this by transmitting one or more applicant data requests 190 to user 135 and receiving in response one or more applicant data responses 187. If user 135 indicates that he or she does have a credit history in the United States, credit decision server 140 may request additional information to determine why the credit file cannot be located. If user 135 indicates that he or she does not have a credit history in the United States, credit decision server 140 may request further information as to the reason. For example, user 135 may not have a credit history due to bankruptcy. As another example, user 135 may not have established a credit history. As another example, user 135 may have recently moved to the United States or may be a foreign national. The method then ends.

At step 710 credit decision server 140 determines whether applicant credit information 197 indicates that user 135 has a high debt level. For example, credit decision server 140 may compare a debt level reflected in applicant credit information 197 to a debt threshold, which may be configured to any suitable value. If the debt level is not greater than the debt threshold, the method proceeds to step 714. If the debt level is greater than the threshold, the method proceeds to step 712 in which debt information is requested. Credit decision server 140 may request debt information by transmitting one or more applicant data requests 190 to user 135 and receiving in response one or more applicant data responses 187. Debt information may include the purpose of the debt. For example, the purpose of the debt may indicate that the credit balance was used for home improvement, for everyday expenses, for a one-time emergency, for cash, or for some other purpose. Debt information may also include the length of time applicant has been carrying the balance or balances. Debt information may also include the monthly payments the applicant makes toward the debt. The monthly payments may include minimum payments, more than minimum payments, balance-in-full payments, or some other form of payments. Debt information may also include any other suitable information according to particular needs.

At step 714 credit decision server 140 determines whether applicant credit information 197 indicates that user 135 has multiple mortgages. Credit decision server 140 may make this determination, for example, by comparing a number of mortgages indicated by applicant credit information 197 to a mortgage threshold, which may be configured to any suitable value. If the number of mortgages is greater than the mortgage threshold, the method proceeds to step 716. If, on the other hand, the number of mortgages is not greater than the mortgage threshold, the method proceeds to step 718. At step 716 credit decision server 140 may confirm that rental income has been reported. Credit decision server 140 may confirm this by transmitting one or more applicant data requests 190 to user 135 and receiving in response one or more applicant data responses 187. Credit decision server 140 may confirm that user 135 included any rental income in the annual income already reported. If user 135 indicates that rental income was not reported, credit decision server 140 may then request and receive rental income information.

At step 718 credit decision server 140 may determine whether applicant credit information 197 indicates a bankruptcy. If credit decision server 140 determines that applicant credit information 197 does indicate a bankruptcy, the method proceeds to step 720. If applicant credit information 197 does not indicate a bankruptcy, the method proceeds to step 722. At step 720 credit decision server 140 requests explanatory information. Explanatory information may be requested by transmitting applicant data request 190 to user 135 and receiving in response one or more applicant data responses 187. Examples of explanatory information may include that applicant's business failed, an applicant life event such as a divorce, that applicant lost his or her job, that applicant had a medical emergency, that applicant was unable to handle the debt level, or some other explanation.

At step 722 credit decision server 140 determines whether applicant credit information 197 indicates a delinquency. If applicant credit information 197 does not indicate a delinquency, the method ends. If applicant credit information 197 indicates a delinquency, the method proceeds to step 724 in which credit decision server 140 requests explanatory information. Explanatory information may be requested by transmitting one or more applicant data requests 190 to user 135 and receiving in response one or more applicant data responses 187. Examples of explanatory information may include a medical emergency on a one-time basis, an ongoing medical issue, a lost job, or any other suitable explanation. The method then ends.

FIG. 8 illustrates an example screenshot of an applicant data collection window 800 that may be generated by the system of FIG. 1, according to certain embodiments of the present disclosure. Applicant data collection window 800 may be one embodiment of GUI 180 of system 100 in which users 135 may view applicant data requests 190 transmitted by credit decision server 140 and input responsive information (e.g. applicant data responses 187), which may then be received by credit decision server 140.

Applicant data collection window 800 provides input fields that allow user 135 to respond to requests for certain personal data. Input fields 802a-d allow user 135 to input applicant's name. Input fields 804a-c allow user 135 to input applicant's phone number. Input field 806 allows user 135 to input applicant's e-mail address. Input fields 808a-808f allow user 135 to input applicant's physical address. Input fields 816a-c allow user 135 to input applicant's social security number. Input fields 818a-c allow user 135 to input applicant's date of birth. Input field 820 allows user 135 to input applicant's mother's maiden name. Input field 822 allows user 135 to input applicant's country of citizenship.

Applicant data collection window 800 also provides input fields that allow user 135 to respond to requests for certain housing data. Input field 810 allows user 135 to input applicant's housing status. Input field 812 allows user 135 to input applicant's monthly housing payment, which may indicate a monthly rental or a monthly mortgage payment. Input field 814 allows user 135 to input the number of years applicant has lived at applicant's current address.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

1. A system, comprising:
a memory operable to store data comprising applicant data collection rules; and
a processor communicatively coupled to the memory and operable to:
receive a credit application request from an applicant directed to a credit entity, the credit application request comprising a product selection;
determine a relationship strength between the applicant and the credit entity;
receive a plurality of responses to requests for applicant data;
determine an applicant classification based at least in part on one or more of the product selection and the relationship strength, the applicant classification comprising one of:
a preferred classification;
a credit builder classification;
a non-relationship classification; and
a student classification;
determine a first set of applicant data collection rules from the applicant data collection rules if the applicant classification is a preferred classification;
determine a second set of applicant data collection rules from the applicant data collection rules if the applicant classification is a credit builder classification;
determine a third set of applicant data collection rules from the applicant data collection rules if the applicant classification is a non-relationship classification
determine a fourth set of applicant data collection rules from the applicant data collection rules if the applicant classification is a student classification; and
customize requests for additional applicant data using the determined set of applicant data collection rules.

2. The system of claim 1, wherein:
the determined set of applicant data collection rules is the first set of applicant data collection rules; and
customizing requests for additional applicant data using the determined set of applicant data collection rules comprises requesting income data.

3. The system of claim 1, wherein:
the determined set of applicant data collection rules is the second set of applicant data collection rules; and
customizing requests for additional applicant data using the determined set of applicant data collection rules comprises:
receiving an employment status;
requesting employer data and income data if the employment status is an employed status;
requesting income data if the employment status is an unemployed status; and
requesting business history data and income data if the employment status is a self-employed status.

4. The system of claim 1, wherein:
the determined set of applicant data collection rules is the third set of applicant data collection rules; and
customizing requests for additional applicant data using the determined set of applicant data collection rules comprises:
receiving an employment status;
requesting employer data and income data if the employment status is an employed status, wherein at least an employment duration is received in response;
requesting prior employment data if the employment status is an employed status and the employment duration is less than a first threshold duration;
requesting income data if the employment status is an unemployed status;
requesting business history data and income data if the employment status is a self-employed status, wherein at least a business duration is received in response; and
requesting additional business history data if the employment status is a self employed status and the business duration is less than a second threshold duration.

5. The system of claim 1, wherein:
the determined set of applicant data collection rules is the fourth set of applicant data collection rules; and
customizing requests for additional applicant data using the determined set of applicant data collection rules comprises:
receiving an employment status;
requesting employer data and income data if the employment status is a full-time employed status, a part-time employed status, a full-time self-employed status, or a part-time self-employed status, wherein at least a total income is received in response;
requesting additional employer data if the employment status is a full-time employed status and the total income is greater than a first income threshold, wherein at least an employment duration is received in response;
requesting additional employer data if the employment status is a part-time employed status and the total income is greater than a second income threshold, wherein at least an employment duration is received in response;
requesting business history data if the employment status is a full-time self-employed status and the total income is greater than a third income threshold, wherein at least a business duration is received in response;
requesting additional employer data if the employment status is a part-time self-employed status and the total income is greater than a fourth income threshold, wherein at least a business duration is received in response; and
requesting income data if the employment status is an unemployed status.

6. The system of claim 5, wherein customizing requests for additional applicant data using the determined set of applicant data collection rules further comprises:
requesting prior employment data if additional employer data has been requested and the employment duration is less than a first threshold duration; and
requesting additional business history data if business history data has been requested and the business duration is less than a second threshold duration.

7. The system of claim 1, wherein:
the data stored in the memory further comprises post-agency data collection rules; and
the processor is further operable to:
determine, based on applicant credit information received from a credit agency server, one or more post-agency data collection rules from the post-agency data collection rules; and
determine whether to request post-agency applicant data based on the determined one or more post-agency data collection rules.

8. The system of claim 7, wherein:
the plurality of responses comprises at least personal data; and
determining whether to request post-agency applicant data based on the determined one or more post-agency data collection rules comprises requesting additional personal data if the applicant credit information indicates a credit search failure.

9. The system of claim 7, wherein determining whether to request post-agency applicant data based on the determined one or more post-agency data collection rules comprises requesting debt information if the applicant credit information indicates a debt level greater than a debt threshold.

10. The system of claim 7, wherein determining whether to request post-agency applicant data based on the determined one or more post-agency data collection rules comprises requesting rental income information if the applicant credit information indicates a number of mortgages and the number is greater than a mortgage threshold.

11. The system of claim 7, wherein determining whether to request post-agency applicant data based on the determined one or more post-agency data collection rules comprises requesting explanatory information if the applicant credit information indicates a negative credit event.

12. The system of claim 1 wherein:
the plurality of responses comprises at least a student indicator; and
determining the applicant classification is further based at least in part on the student indicator.

13. A system, comprising:
a processor; and
one or more non-transitory computer readable storage media embodying software that is operable when executed by the processor to:
receive a credit application request from an applicant directed to a credit entity, the credit application request comprising a product selection;
determine a relationship strength between the applicant and the credit entity, receive a plurality of responses to requests for applicant data;
determine an applicant classification based at least in part on one or more of the product selection and the relationship strength;
determine, based on the applicant classification, one or more applicant data collection rules; and
customize requests for additional applicant data using the determined one or more applicant data collection rules.

14. The system of claim 13, wherein:
the applicant classification is a preferred classification; and
customizing requests for additional applicant data using the determined one or more applicant data collection rules comprises requesting income data.

15. The system of claim 13, wherein:
the applicant classification is a credit builder classification; and
customizing requests for additional applicant data using the determined one or more applicant data collection rules comprises;
receiving an employment status;
requesting employer data and income data if the employment status is an employed status;
requesting income data if the employment status is an unemployed status; and
requesting business history data and income data if the employment status is a self-employed status.

16. The system of claim 13, wherein:
the applicant classification is a non-relationship classification; and
customizing requests for additional applicant data using the determined one or more applicant data collection rules comprises:
receiving an employment status;
requesting employer data and income data if the employment status is an employed status, wherein at least an employment duration is received in response;
requesting prior employment data if the employment status is an employed status and the employment duration is less than a first threshold duration;
requesting income data if the employment status is an unemployed status;
requesting business history data and income data if the employment status is a self-employed status, wherein at least a business duration is received in response; and
requesting additional business history data if the employment status is a self-employed status and the business duration is less than a second threshold duration.

17. The system of claim 13, wherein:
the applicant classification is a student classification; and
customizing requests for additional applicant data using the determined one or more applicant data collection rules comprises:
receiving an employment status;
requesting employer data and income data if the employment status is a full-time employed status, a part-time employed status, a full-time self-employed status, or a part-time self-employed status, wherein at least a total income is received in response;
requesting additional employer data if the employment status is a full-time employed status and the total income is greater than a first income threshold, wherein at least an employment duration is received in response;
requesting additional employer data if the employment status is a part-time employed status and the total income is greater than a second income threshold, wherein at least an employment duration is received in response;
requesting business history data if the employment status is a full-time self-employed status and the total income is greater than a third income threshold, wherein at least a business duration is received in response;
requesting additional employer data if the employment status is a part-time self-employed status and the total income is greater than a fourth income threshold, wherein at least a business duration is received in response; and
requesting income data if the employment status is an unemployed status.

18. The system of claim 17, wherein customizing requests for additional applicant data using the determined one or more applicant data collection rules further comprises:
requesting prior employment data if additional employer data has been requested and the employment duration is less than a first threshold duration; and
requesting additional business history data if business history data has been requested and the business duration is less than a second threshold duration.

19. The system of claim 13, wherein the software is further operable when executed by the processor to:
determine, based on applicant credit information received from a credit agency server, one or more post-agency data collection rules; and
determine whether to request post-agency applicant data based on the determined one or more post-agency data collection rules.

20. A method, comprising:
receiving, by a processor, a credit application request from an applicant directed to a credit entity, the credit application request comprising a product selection;
determining, by the processor, a relationship strength between the applicant and the credit entity;
receiving, by the processor, a plurality of responses to requests for applicant data;
determining, by the processor, an applicant classification based at least in part on one or more of the product selection and the relationship strength;
determining, by the processor, based on the applicant classification, one or more applicant data collection rules; and
customizing, by the processor, requests for additional applicant data using the determined one or more applicant data collection rules;

21. The method of claim 20, wherein:
the applicant classification is a preferred classification; and
customizing requests for additional applicant data using the determined one or more applicant data collection rules comprises requesting income data.

22. The method of claim 20, wherein:
the applicant classification is a credit builder classification; and
customizing requests for additional applicant data using the determined one or more applicant data collection rules comprises:
receiving an employment status;
requesting employer data and income data if the employment status is an employed status;
requesting income data if the employment status is an unemployed status; and
requesting business history data and income data if the employment status is a self-employed status.

23. The method of claim 20, wherein:
the applicant classification is a non-relationship classification; and
customizing requests for additional applicant data using the determined one or more applicant data collection rules comprises:
receiving an employment status;
requesting employer data and income data if the employment status is an employed status, wherein at least an employment duration is received in response;
requesting prior employment data if the employment status is an employed status and the employment duration is less than a first threshold duration;
requesting income data if the employment status is an unemployed status;
requesting business history data and income data if the employment status is a self-employed status, wherein at least a business duration is received in response; and
requesting additional business history data if the employment status is a self-employed status and the business duration is less than a second threshold duration.

24. The method of claim 20, wherein:
the applicant classification is a student classification; and
customizing requests for additional applicant data using the determined one or more applicant data collection rules comprises:
receiving an employment status;
requesting employer data and income data if the employment status is a full-time employed status, a part-time employed status, a full-time self-employed status, or a part-time self-employed status, wherein at least a total income is received in response;
requesting additional employer data if the employment status is a full-time employed status and the total income is greater than a first income threshold, wherein at least an employment duration is received in response;
requesting additional employer data if the employment status is a part-time employed status and the total income is greater than a second income threshold, wherein at least an employment duration is received in response;
requesting business history data if the employment status is a full-time self-employed status and the total income is greater than a third income threshold, wherein at least a business duration is received in response;
requesting additional employer data if the employment status is a part-time self-employed status and the total income is greater than a fourth income threshold, wherein at least a business duration is received in response; and
requesting income data if the employment status is an unemployed status.

25. The method of claim 24, wherein customizing requests for additional applicant data using the determined one or more collection rules further comprises:
requesting prior employment data if additional employer data has been requested and the employment duration is less than a first threshold duration; and
requesting additional business history data if business history data has been requested and the business duration is less than a second threshold duration.

26. The method of claim 20, further comprising:
determining, by the processor, based on applicant credit information received from a credit agency server, one or more post-agency rules from post-agency data collection rules stored in the memory; and
determining, by the processor, whether to request post-agency applicant data based on the determined one or more post-agency rules.
